(19) United States
(12) Patent Application Publication
(10) Pub. No.: US 2013/0169227 A1
(43) Pub. Date: Jul. 4, 2013

(54) MODULAR CHARGING STATION

(71) Applicants: Louis Tremblay, Quebec (CA); Michael Desjardins, Quebec (CA)

(72) Inventors: Louis Tremblay, Quebec (CA); Michael Desjardins, Quebec (CA)

(21) Appl. No.: 13/822,751

(22) PCT Filed: Sep. 13, 2011
(86) PCT No.: PCT/CA11/01044

§ 371 Date: Mar. 13, 2013

Related U.S. Application Data
(60) Provisional application No. 61/382,097, filed on Sep. 13, 2010.

(51) Int. Cl. B60L 11/18

(52) U.S. Cl. CPC B60L 11/1824
USPC 320/109

(57) ABSTRACT

A modular charging station for charging an electric vehicle, the modular charging station comprising: a frame having a receiving portion; a control unit removably secured to the receiving portion of the frame and electrically connectable to a source of electrical energy, the control unit for selectively controlling access to the electrical energy; and a distributing unit removably secured to the frame, electrically connected to the control unit for receiving the electrical energy therefrom, and electrically connectable to the electric vehicle for providing the electrical energy to the electric vehicle, a powering of the distributing unit being controlled by the control unit.

### CROSS REFERENCE TO RELATED APPLICATION

This application claims priority of US Provisional Patent Application having Ser. No. 61/382,097, which was filed on Sep. 13, 2010 and is entitled “MODULAR CHARGING STATION”, the specification of which is hereby incorporated by reference.

### FIELD OF THE INVENTION

This invention relates to electrical distribution and dispensing. More precisely, the invention pertains to a modular charging station for providing electrical energy to batteries powered devices such as electric or plug-in hybrid vehicles for example. The charging station has a modular design enabling various configurations.

### BACKGROUND OF THE INVENTION

Electrical vehicles become widely used. Some of them are hybrid type vehicles having both an electric motor coupled to an electric rechargeable battery and an internal conventional combustion engine.

Recharging of hybrid vehicles may take place from the internal combustion engine and/or from waste energy recovered during braking phases. They may also be recharged by simply buying electricity and transferring it into the batteries, provided they have the plug-in capability.

Typically, the user will recharge the electric battery of his vehicle in connecting the battery to the power grid via a suitable plug. In this case, the user will generally use the connection to the power grid that is available at his residence.

Some fully electric vehicles may not yet have an autonomy suitable for enabling the user to travel a long way without recharging the batteries, once they are depleted, to further postpone the recharging of the batteries of the vehicle. In this case, the user may have to recharge his batteries outside his residence, for example in a charging station available to the public upon payment of a fee.

Different types of charging stations and associated methods adapted for distributing electricity to electric vehicles have been proposed.

As known to the skilled addressee, for level 1 and level 2, a charger is typically provided in the car, so the charging stations are typically energy access spots for electric cars. Those stations do not know in any case the parameters of the batteries. It is the charger in the car that performs the charging, knowing the proper parameters of the batteries pack. In level 3 chargers, the car controls the fast charging station in a master-slave relationship.

These charging stations, when used in harsh climatic conditions such as during winter in northern countries like Canada, may not be very convenient for the user. Indeed, they may be inoperative more often and they may also contribute to soil the user suit in the case the charging cable has not been properly replaced by the previous user.

Furthermore, the installation of a complete set of electric charging stations may be quite expensive. Thus, once they are installed, the manager of the stations may not accept to change the charging stations often, even if not well adapted for an optimal charging of the vehicles.

In order to better accommodate the users of such electric vehicles and also in order to encourage the expansion of the use of such vehicles, convenient charging stations available at different locations and adapted for recharging the vehicles under optimal conditions are needed. Moreover, a charging station that may be easily updated according to new technological features would be advantageous for a manager of a complete set of charging station.

It is therefore desirable to provide an improved charging station that would reduce at least one of the above mentioned drawbacks.

### BRIEF SUMMARY

In accordance with a broad aspect, there is provided a modular charging station for charging an electric vehicle, the modular charging station comprising: a frame having a receiving portion; a control unit removably secured to the receiving portion of the frame and electrically connectable to a source of electrical energy, the control unit for selectively controlling access to the electrical energy; and a distributing unit removably secured to the frame, electrically connected to the control unit for receiving the electrical energy therefrom, and electrically connectable to the electric vehicle for providing the electrical energy to the electric vehicle, a powering of the distributing unit being controlled by the control unit.

In one embodiment, the control unit comprises a receiving cavity for removably receiving the distributing unit therein. The shape of a rear face of the control unit may match the shape of the receiving cavity for a snuggly relationship between the control unit and the frame. In one embodiment, the frame comprises an elongated V-shaped extrusion.

In one embodiment, the control unit comprises a first electrical connector positioned in the receiving cavity and electrically connected to the source of electrical energy, and the distributing unit comprises a second electrical connector. The first and second electrical connectors are positioned so that an insertion of the distributing unit in the receiving cavity electrically connects the first and second electrical connectors together.

In one embodiment, the control unit comprises a switch for activating a powering of the distributing unit, a first electrical connector connected to the switch and connectable to the source of electrical energy, and a second electrical connector connected to the switch and the distributing unit. The distributing unit may comprise a third electrical connector electrically connected to the second electrical connector for receiving the electrical energy therefrom.

In one embodiment, the first, second, and third electrical connectors are plug-in connectors.

In one embodiment, the distributing unit comprises a vehicle electrical connector adapted to connect to the electric vehicle. The vehicle electrical connector may be fixedly secured to a connector receiving portion of the distributing unit. In another embodiment, the charging station further comprises a flexible cable electrically connecting the vehicle electrical connector to the distributing unit and the distributing unit further comprises a connector receiving portion for holding the vehicle electrical connector thereon. In this case, the frame may further comprise a cable receiving portion for receiving the flexible cable. In one embodiment, the charging station comprises a retracting mechanism for retracting the flexible cable in the cable receiving portion. The flexible cable may be provided with a handle.

In one embodiment, the modular charging station comprises a position sensor operatively connected to the control unit and adapted for determining whether the vehicle electrical connector is positioned on the connector receiving portion. The processing unit of the control unit is configured for terminating a transaction only if the position sensor detects that the vehicle electrical connector is positioned on the connector receiving portion.

In one embodiment, the frame comprises a further receiving portion for removably receiving the distributing unit therein, the distributing being directly and removably secured to the frame.

In one embodiment, the control unit comprises an identification module for identifying a user and powering the energy providing means upon successful identification of the user.

In one embodiment, the modular charging station comprises a communication unit for remote communication.

In one embodiment, the control unit comprises an electricity meter for measuring an amount of electrical energy consumed during the charge of the vehicle.

The modularity of the charging station may help reducing down time of the whole system since a defective modular component may be easily replaced and repaired at a later time and/or at another location without disrupting the operating of the whole system, which may be of great advantage.

In one embodiment, the charging station is adapted for use in harsh climatic conditions, which may be of great advantage.

Thanks to its modularity, the charging station may be tailored according to specific needs of the given location, which may be of great advantage.

### BRIEF DESCRIPTION OF THE DRAWINGS

In order that the invention may be readily understood, embodiments of the invention are illustrated by way of example in the accompanying drawings.

FIG. 1 is a front view of a modular charging station, according to one embodiment.

FIG. 2 is a side view of the modular charging station shown in FIG. 1.

FIG. 3 is a front view of a wall mount or pole mount modular charging station, according to another embodiment.

FIG. 4 is another front view of the modular charging station shown in FIG. 1.

FIG. 5 is a cross sectional side view of the modular charging station shown in FIG. 4, taken along lines C-C.

FIG. 6A is an exploded front perspective view of a charging station comprising a control unit wiredly connected to a source of electrical energy, in accordance with an embodiment.

FIG. 6B is an exploded front perspective view of a charging station comprising a control unit having a connector for connection to a source of electrical energy, in accordance with an embodiment.

FIG. 7 is an exploded front perspective view of a portion of the charging station shown in FIG. 1.

FIG. 8 is a front perspective view of another portion of the charging station shown in FIG. 1.

FIG. 9 is a front view of another modular charging station, according to another embodiment.

FIG. 10 is a top view of the modular charging station shown in FIG. 9.

FIG. 11 is a front view of another modular charging station, according to another embodiment.

FIG. 12 is a front perspective view of the modular charging station shown in FIG. 11.

FIG. 13 is a top view of the modular charging station shown in FIG. 11.

FIG. 14 is a perspective view of a connector of a modular charging station usable for connecting to an electric vehicle, according to one embodiment.

FIG. 15A is a block diagram of a modular charging station, according to one embodiment.

FIG. 15B illustrates the connection between the block elements of FIG. 15A.

FIGS. 16A to 16C show another embodiment of a modular charging station.

FIG. 17 shows still another embodiment of a modular charging station.

FIG. 18 shows yet another embodiment of a modular charging station.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

There is disclosed a charging station for electricity dispensing which is of a modular construction. The modularity of the charging station may help reducing down time of the whole system since a defective modular component may be easily replaced and repaired at a later time and/or at another location without disrupting the operating of the whole system, which may be of great advantage, as detailed below.

Moreover, thanks to its modularity, the charging station may be tailored according to specific needs of the given location at which it is installed, for example for enabling electricity distribution to several different users at the same time with a single frame, as it will become apparent below.

The modularity of the charging station may help cutting down production costs. Indeed, the charging station is designed so that several elements may be interchanged with different types of the same element. This may be of great advantage when the charging stations are to be used in various countries having different electrical networks since different controls and/or standard connectors may be implemented without having to redesign the whole charging station.

The modularity of the charging station may also help keeping the operating costs low. Indeed, if an update should be made to the charging stations, only the concerned element may be changed, without requiring an expensive change of the whole stations for new ones.

In one embodiment, the charging station is adapted for use in harsh climatic conditions, such as winter in northern countries such as Canada. As it will become apparent below upon reading of the present description, the construction of the charging station is devised to resist to heavy conditions such as snow, ice, cold and most of debris, while offering an easy and convenient experience to the user.

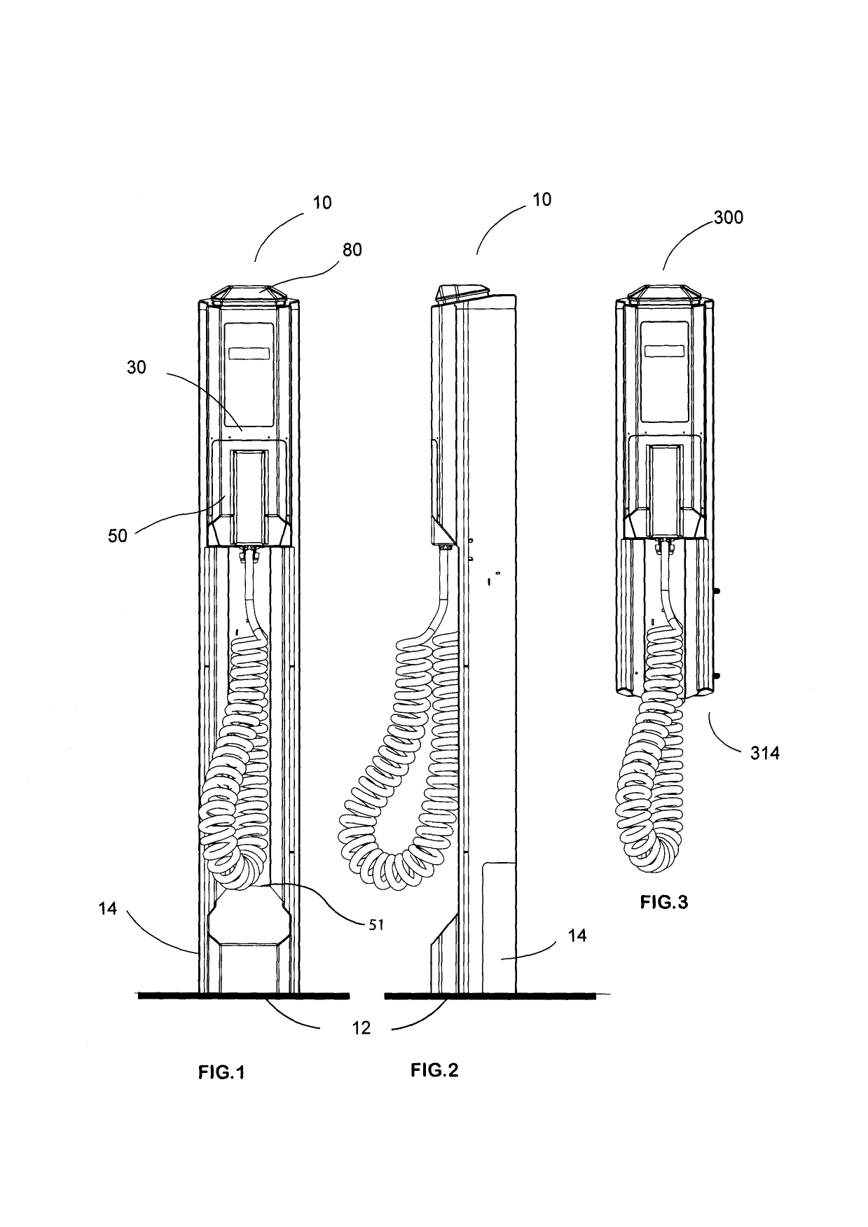

Referring to FIG. 1, there is shown a modular charging station 10 for providing electrical energy at a given location. The modular charging station 10 may be used in a private space, such as at the residence of the user, or may also be used as a public charging station. In this latter case, the user may approach his electric car proximate the charging station as he would do with a conventional gasoline pump, present a credit card to the station or otherwise arrange for payment, operatively connect the vehicle to the charging station and in turn be provided with electricity.

The charging station may provide either standard line voltage of sufficient current to charge the batteries, or a particular voltage power necessary for the charging. After the vehicle is charged, the amount of power provided may be calculated, and either the credit card debited for the correct amount, or other arrangements to pay for the service may be accommodated such as debiting a prepaid account, as known in the art.

In the case of a private or semi-private dispensing station, several users may share the same station as subscribers, and may identify themselves to the station by key access with password, by card swipe, or by presenting a card containing an RFID chip that contains their identity. Service provided could then be billed to a prepaid or subscriber account.

Referring to FIGS. 1 and 2, the modular charging station 10 comprises a base 12 for anchoring the charging station 10 at the given location and a frame 14 attachable to the base 12. In the illustrated embodiment, the base 12 is adapted for lying on the ground or to be attached on a horizontal receiving surface for providing a floor mount configuration.

Referring to FIG. 3, there is shown another embodiment of a modular charging station 300 which is adapted for a wall mount configuration. Such configuration may be particularly advantageous for a private use since it may help providing a more compact charging station. In this case, the base (not shown) may be adapted for being attached to a vertical wall (not shown) while the frame 314 is attachable to the base.

In one embodiment, the base 12 may be omitted so that the frame would be directly secured to the floor, the vertical wall, or any other adequate receiving surface.

The modular charging station 300 shown in FIG. 3 may also be mounted on a pole (not shown), as it should become apparent to the skilled addressee.

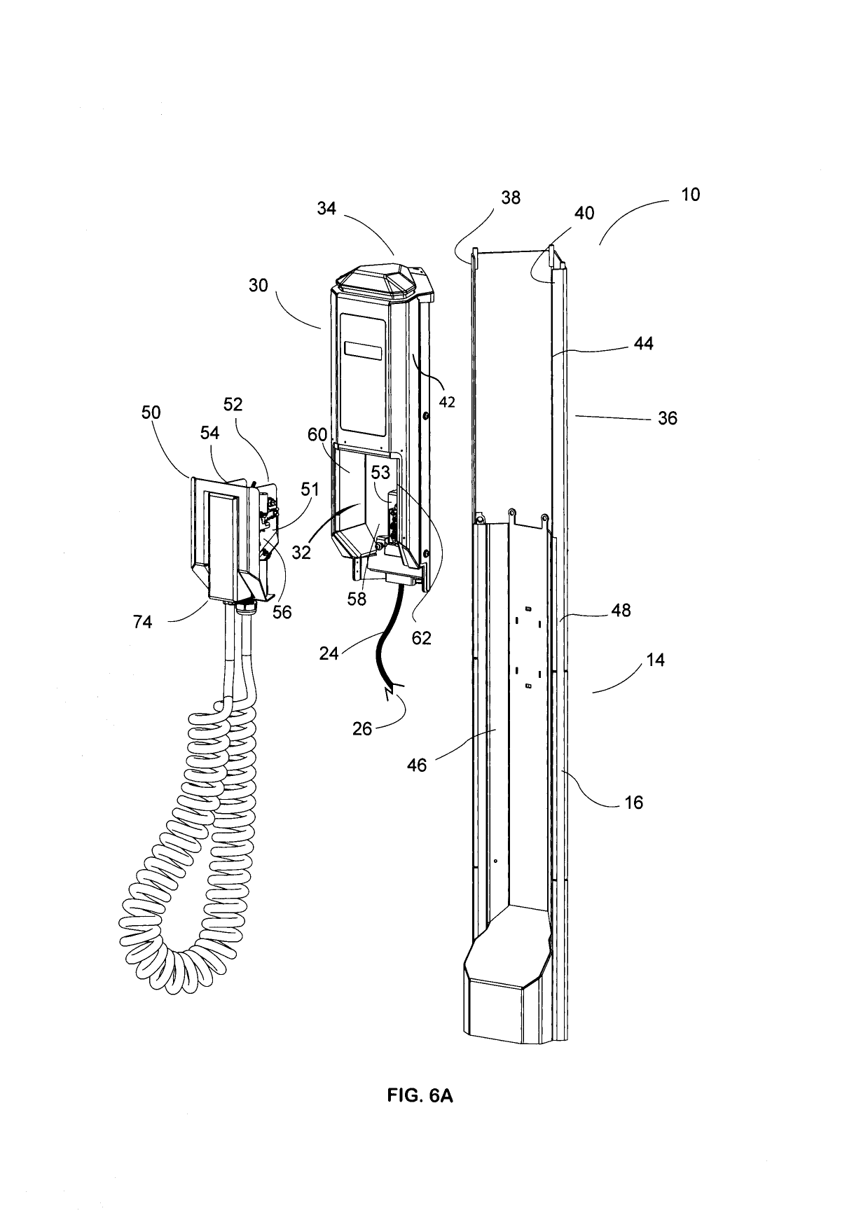

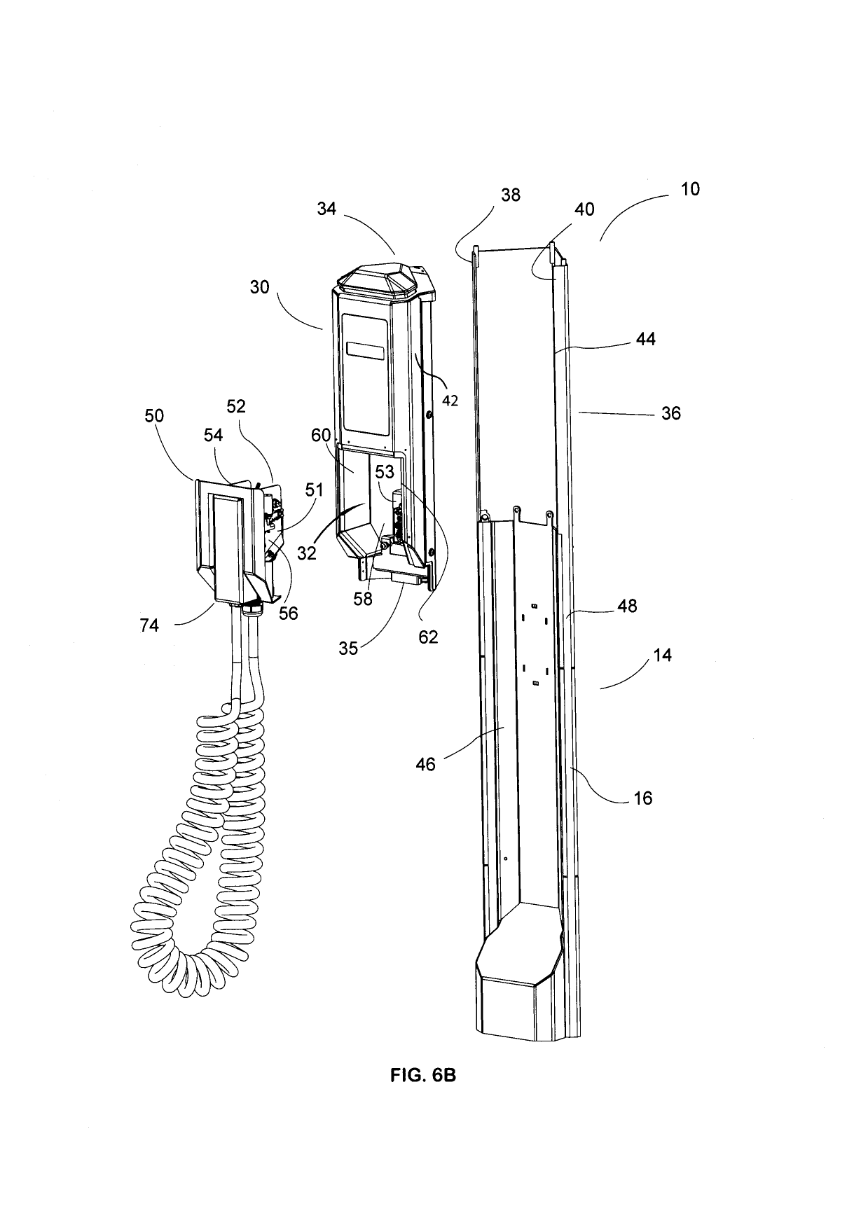

As illustrated in FIGS. 6A and 6B, the modular charging station 10 comprises a control unit 30 and a distributing unit 50 which are each removably secured to the frame 14 of the modular charging station 10. The control unit 30 is adapted to control the electrical power provided to a user's vehicle and the distributing unit 50 is adapted to electrically connect to a battery or a charger of the vehicle for charging the battery, i.e. for providing electrical energy to the vehicle. The control unit 30 is electrically connected to a source of electrical energy such as an electrical grid for example, and the distributing unit 50 is electrically connected to the control unit 30 for receiving electrical energy therefrom and providing the received electrical energy to the vehicle to be charged.

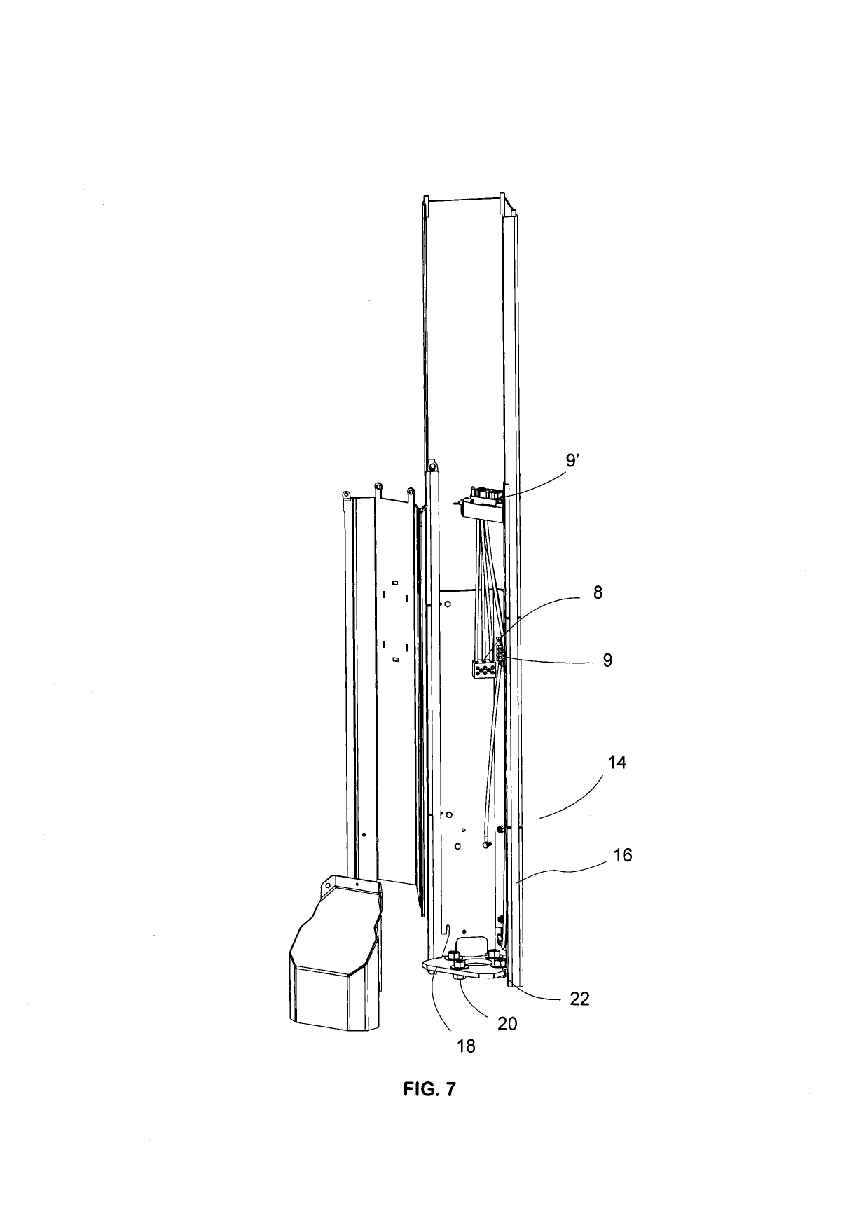

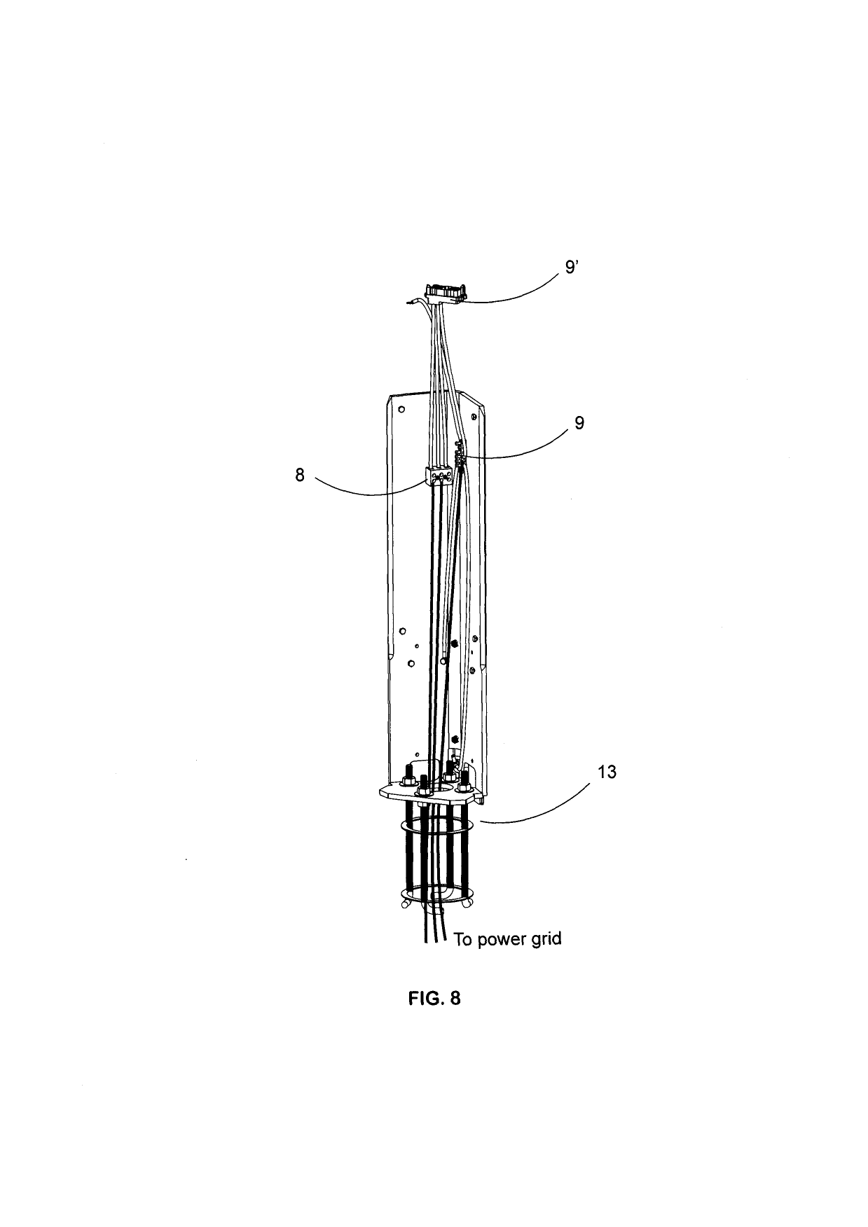

Referring to FIGS. 7 and 8, in one embodiment, the base 12 comprises a plate disposed horizontally. In one embodiment, the base 12 is secured to the floor with fasteners (not shown) in order to prevent removal or theft of the charging station 10. In one embodiment, the base 12 comprises an aperture (not shown) therethrough for receiving an electrical cable connected to the power grid or an electric source, as it will become apparent below.

In one embodiment, as illustrated, the frame 14 comprises an elongated V-shaped extrusion 16. In this embodiment, the frame 14 also comprises a connecting plate 18 (shown in FIG. 7) secured to the extrusion 16 and adapted for attachment on the base 12. In the illustrated embodiment, screws and bolts 20, 22 are used for attaching the frame 14 to the base 12 but the skilled addressee will appreciate that various others arrangements may be alternatively used.

It should be understood that the frame 14 may have any adequate shape which allows the control unit 30 and the distributing unit 50 to be removably secured thereto. For example, the frame 14 may have a substantially U-shape, a substantially half-circular shape, or the like.

Referring again to FIG. 6A and in accordance with one embodiment, the modular charging station 10 comprises an electrical connection 24 having a first end 26 operatively connectable to a source of electrical energy such as an electrical grid or a source of renewable energy for example, and a second end 28 connected to the control unit 50. In one embodiment, the first end 26 of the electrical connection 24 is connected to the power grid only in order to dispense energy available through the power grid. In another embodiment, the first end 26 of the electrical connection 24 may be connected to a renewable source only. It may be of great advantage for dispensing electrical energy to vehicles in remote or distant areas where the power grid cannot be easily accessed or is just not available. In a further embodiment, the first end 26 of the electrical connection 24 may be connected to both the power grid and a renewable energy source, as it should be apparent to the skilled addressee.

In another embodiment, the control unit 50 is provided with an electrical connector 35, such as a plug-in or snap electrical connector for example, to be electrically connected to the source of electrical energy, as illustrated in FIG. 6B.

In one embodiment, as illustrated in FIGS. 7 and 8, electrical connectors 8, 9, and 9′ are used for electrically connecting the control unit 30 to the source of electrical energy. In one embodiment, the electrical connector 9′ is adapted to be connected to the end 26 of the electrical connection 24. In another embodiment, the electrical connector 9′ is adapted to be connected to the connector 35 of the control unit 30 for powering both the control unit 30 and the distributing unit 50. In this case, the connector 9′ may be a plug-in or snap connector mating the connector 35, for example.

The electrical connector 9′ is electrically connected to the electrical connectors 8 and 9. The connector 8 is electrically connected to the source of electrical energy while the connector 9 is grounded. For example, the connector 9 may be connected to a power panel so as to be grounded. The connectors 8, 9, and 9′ may be located in a recess portion of the frame 14 located in a lower portion thereof.

This may be of great advantage for reducing installation and maintenance costs. Indeed, at the initial installation, a certified electrician may be required to connect the electrical connector 8 to the source of electrical energy, the connector 9 to the ground, and the electrical connectors 8 and 9 to the electrical connector 9′. Then, a technician may finalize the installation in electrically connecting the control unit 30 to the connector 9′, i.e. electrically connecting the connectors 35 and 9′ together. If it has to replaced, the control unit 30 is simply removed from the frame 14 and the connectors 35 and 9′ are disconnected from one another.

In another embodiment, an electrical junction box is used for providing an electrical connection between the charging station and the power grid. The junction box may be placed between the electrical connection 24 or the connector 35 and the source of electrical energy so as to be electrically connected to the source of electrical energy. In one embodiment, the junction box is mounted in the frame 14, in a lower portion thereof. This may be of great advantage for reducing installation and maintenance costs. Indeed, at the initial installation, a certified electrician may be required to install the junction box and effect the electrical connection between the power grid and the charging station. Then, a technician may finalize the installation in connecting the electronics of the charging station 10 to the junction box.

Referring to FIGS. 1, 6A, and 6B and as described above, the modular charging station 10 comprises a control unit 30 comprising a memory and a processing unit configured for selectively controlling access to the electrical energy, as it will become apparent below. The control unit 30 is removably attached to the frame 14 and has a receiving cavity 32 therein for receiving the distributing unit 50.

In one embodiment, the control unit 30 comprises a switch for selectively powering the distributing unit 50. The switch is controlled by the processing unit of the control unit 30. In one embodiment, upon determination that the user is permitted to use the charging station, the processing unit of the control unit 30 turns the switch on to power the distributing unit 50.

In one embodiment, the control unit 30 has a shape matching that of the frame 14 or a receiving portion of the frame 14 so as to be inserted in the frame 14. In the illustrated embodiment, the control unit 30 has a back face 34 which is V-shaped in order to be mountable in the frame 14. In this case, the elongated frame 14 may be provided with an upper receiving portion 36 adapted for receiving the back face 34 of the control unit 30 in a snugly relationship. The upper receiving portion 36 adapted for receiving the back face 34 may be provided, in one embodiment, with outer lips or rails 38, 40 devised to hold the control unit 30 in position and removably secure the control unit 30 to the frame 14.

In the same or another embodiment, cooperating fasteners 42, 44 may be provided on both the control unit 30 and the frame 14 for releasably securing the control unit 30 to the frame 14 and preventing an unwanted removal thereof. In still a further embodiment, a special tool may be required for removing the control unit 30 from the frame 14, as known in the art. For example, the fasteners may be torque nuts having an unusual head shape and the special tool may be a screwdriver adapted to the unusual shape of the torque nut head. The skilled addressee will however appreciate that various other arrangements for removably securing the control unit 30 to the frame 14 may be considered.

In one embodiment, the upper portion 36 of the frame 14 may be made flexible for enabling snapping the control unit 30 in place. In this case, the control unit 30, thanks to its beveled back face 34, may be forced inside the upper portion 36 which flex outwardly. Once the control unit 30 in place, the sides 46, 48 of the upper portion 36 will return to their natural positions to thereby hold the control unit 30 in place and removably secure the control unit 30 to the frame 14.

In another embodiment, the control unit 30 may be slid vertically into the upper portion 36 of the frame 14 and removably held in position with fasteners, as it should become apparent to the skilled addressee. During the insertion of the control unit 30 in the receiving portion 36, the lips 38, 40 guide the control unit 30 in the receiving portion 36 in addition to hold the control unit 30 in the receiving portion 36. In one embodiment, the upper portion 34 of the frame 14 may be shaped with at least one lower abutting member. In this case, the control unit 30 may be slid into the frame 14 until it abuts on the abutting member.

In one embodiment, the base 12 may be made from a rigid metallic material such as aluminum. In another embodiment, the frame 14 may be made from metallic or plastic material. In a further embodiment, the control unit 30 is embedded in an outer casing made from metallic or plastic material. The skilled addressee will nevertheless appreciate that other materials and combination thereof may be considered.

In one embodiment wherein the charging station is a public one, it may be advantageous that the station be made robust. In this case, metallic material such as aluminum may be preferred. In another embodiment wherein the station is a private one, plastic may be used for reducing manufacturing costs. The skilled addressee will nevertheless appreciate that various other materials may be used for various parts of the described charging station.

Still referring to FIGS. 1 and 6 and as described above, the modular charging station 10 comprises a distributing unit 50 mountable in the receiving cavity 32 of the control unit 30.

In one embodiment, the back face 52 and the side faces 54, 56 of the distributing unit 50 as well as the back face 58 and the side faces 60, 62 of the receiving cavity 32 of the control unit 30 are shaped to cooperate together in order to receive the distributing unit 50 in a snuggly relationship. In one embodiment, the distributing unit 50 may be snapped into the receiving cavity 32 of the control unit 30.

It should be understood that any adequate method for electrically connecting the control unit 30 and the distributing unit 50 together may be used. For example, an electrical cable may removably connect the distributing unit 50 to the control unit 30 in order to receive electrical energy and charge the battery of a vehicle. In another example, the control unit 30 and the distributing unit 50 may be provided with mating connectors such as snap connectors. Referring to FIG. 6, the control unit 30 is provided with an electrical connector 53 on the back face 58 of the receiving cavity 32, and the distributing unit 50 is provided with a mating electrical connector 51 on its back face 52. The electrical connectors 51 and 53 are positioned to face each other during the insertion of the distributing unit 50 into the receiving cavity 32 of the control unit 30 so that, when the distributing unit 50 is inserted in the receiving cavity 32, the electrical connectors 51 and 53 removably connect together for removably and electrically connecting the distributing unit 50 to the control unit 30 and no electrical cable is required.

In one embodiment, fasteners (not shown) may be used for securing the distributing unit 50 in the receiving cavity 32 and thereby preventing an unwanted removal thereof. In still a further embodiment, a special tool, such as the one described above, may be required for removing the distributing unit 50 from the control unit 30, as known in the art. The skilled addressee will however appreciate that various other arrangements for securing the distributing unit 50 in the control unit 30 may be considered.

While in the above described embodiment, the distributing unit 50 is removably secured to the frame 14 of the modular charging station via the control unit, i.e. the control unit 30 comprises a receiving cavity 32 for removably receiving the distributing unit 50 therein, it should be understood that other adequate configurations are possible. For example, the frame 14 may be provided with a first receiving portion and a second receiving portion adjacent together for respectively receiving the control unit 30 and the distributing unit 50. The receiving portions may each be a separate cavity in the frame 14.

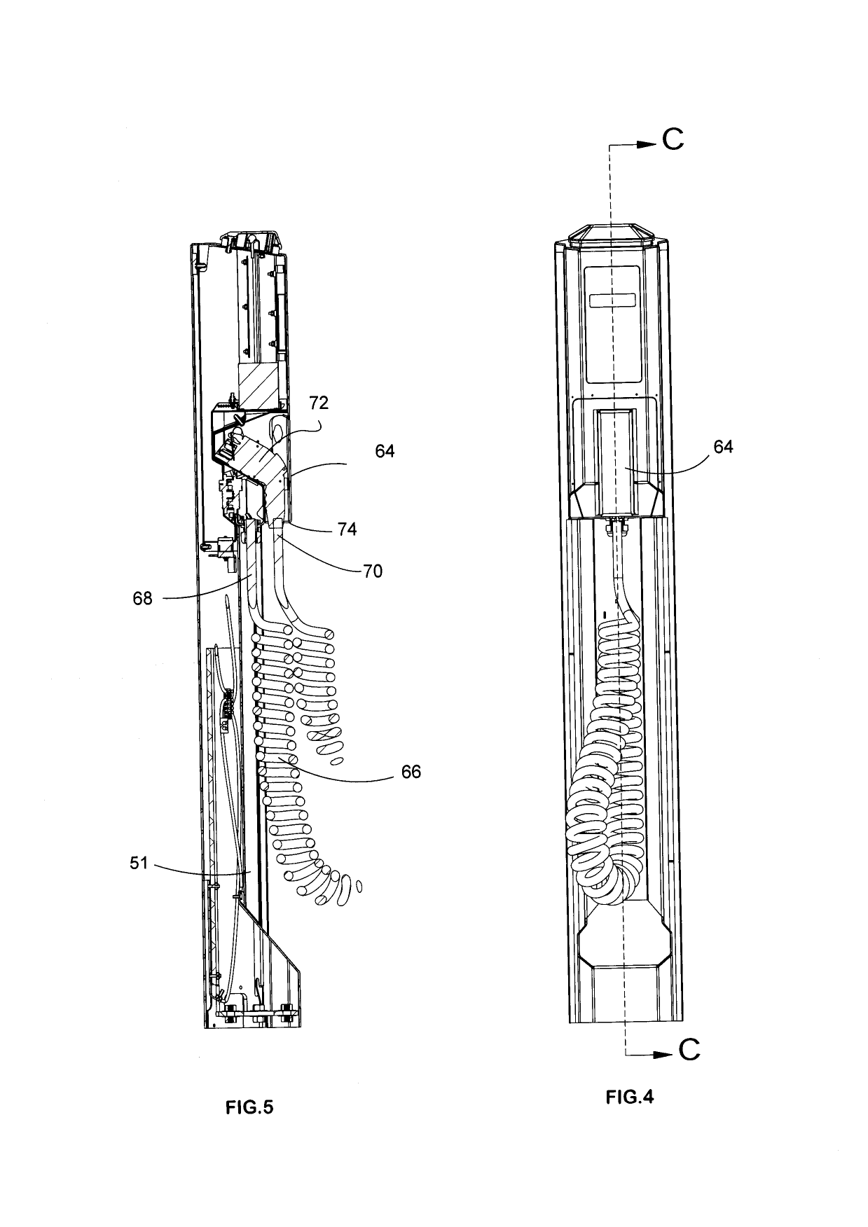

Referring to FIGS. 4, 5 and 6, the distributing unit 50 has an energy providing means 64 operatively connected to the second end 28 of the electrical connection 24 and is adapted for selectively providing the electrical energy to a battery powered device such as a vehicle in the described example. The energy providing means 64 is adapted to connect to a battery or a charger of the vehicle to be charged.

Indeed, the control unit 30 which is operatively connected to the distributing unit 50 controls access to the electrical energy in selectively enabling and preventing distribution of electrical energy, i.e. selectively powering the energy providing means 64. In one embodiment, the control unit 30 is adapted to identify the vehicle or the user of the vehicle as well known in the art to thereby provide energy through the electrical connector 64, as detailed below.

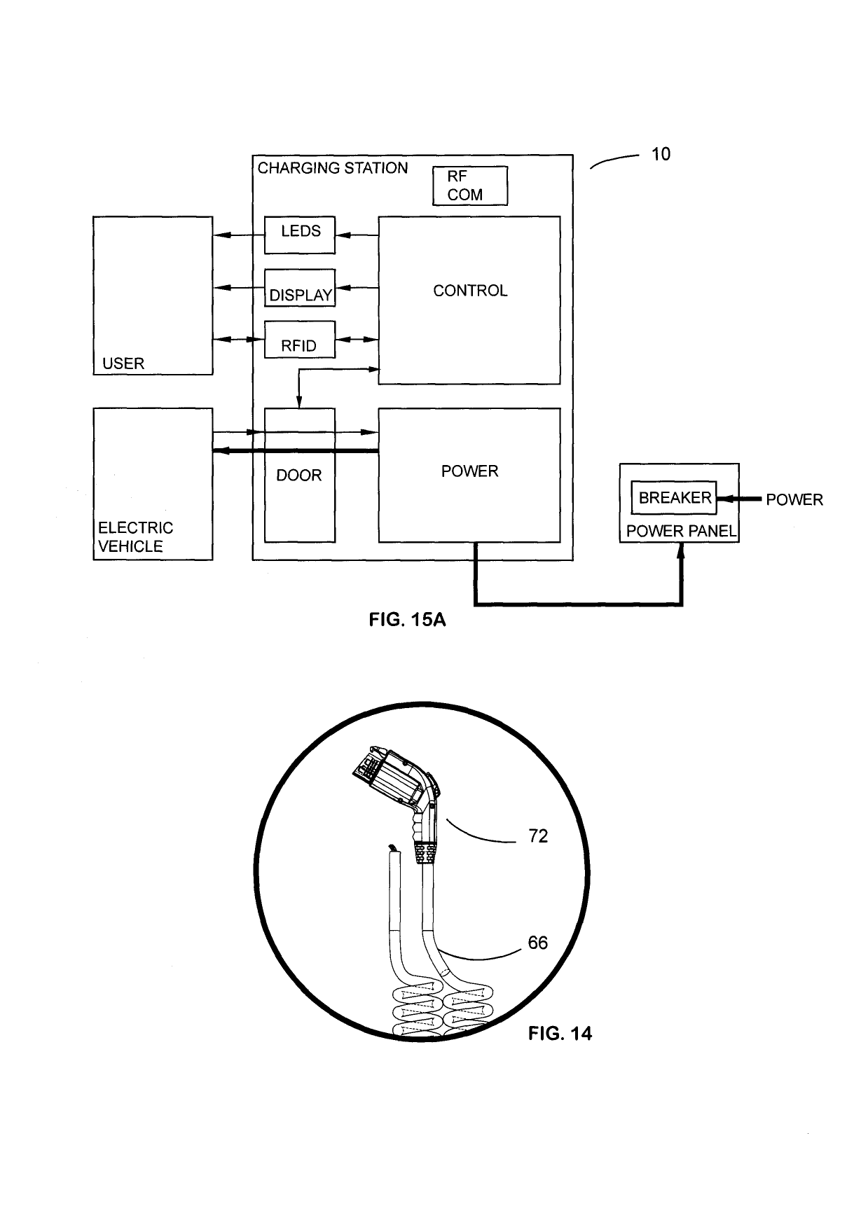

Referring to FIGS. 1, 5 and 14 and in accordance with one embodiment, the energy providing means 64 comprises a flexible electrically conductive cable 66 having a first end 68 operatively connected to the electrical connector 51 and a second end 70 provided with a connector 72 adapted for operatively connecting with a corresponding connector (not shown) provided on the battery or charger of the electrical vehicle to be charged.

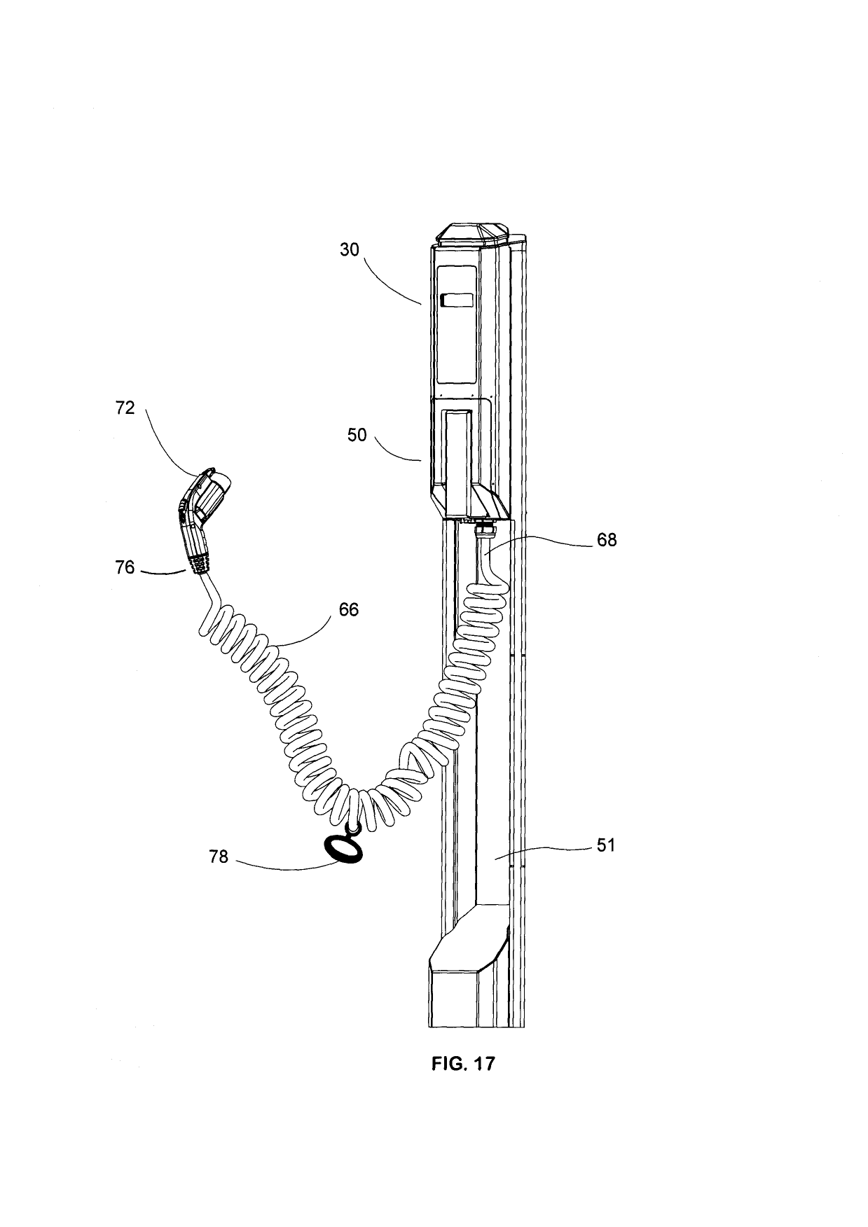

Referring to FIG. 17, in one embodiment, the flexible conductive cable 66 is firmly attached proximate its first end 68 to the distributing unit 50 or the control unit 30. In one embodiment, the frame 14 comprises a lower cable receiving portion 51 which is adapted to receive and protect the cable 66 when not in use. It is worth mentioning that various other configurations may be envisaged for a given application.

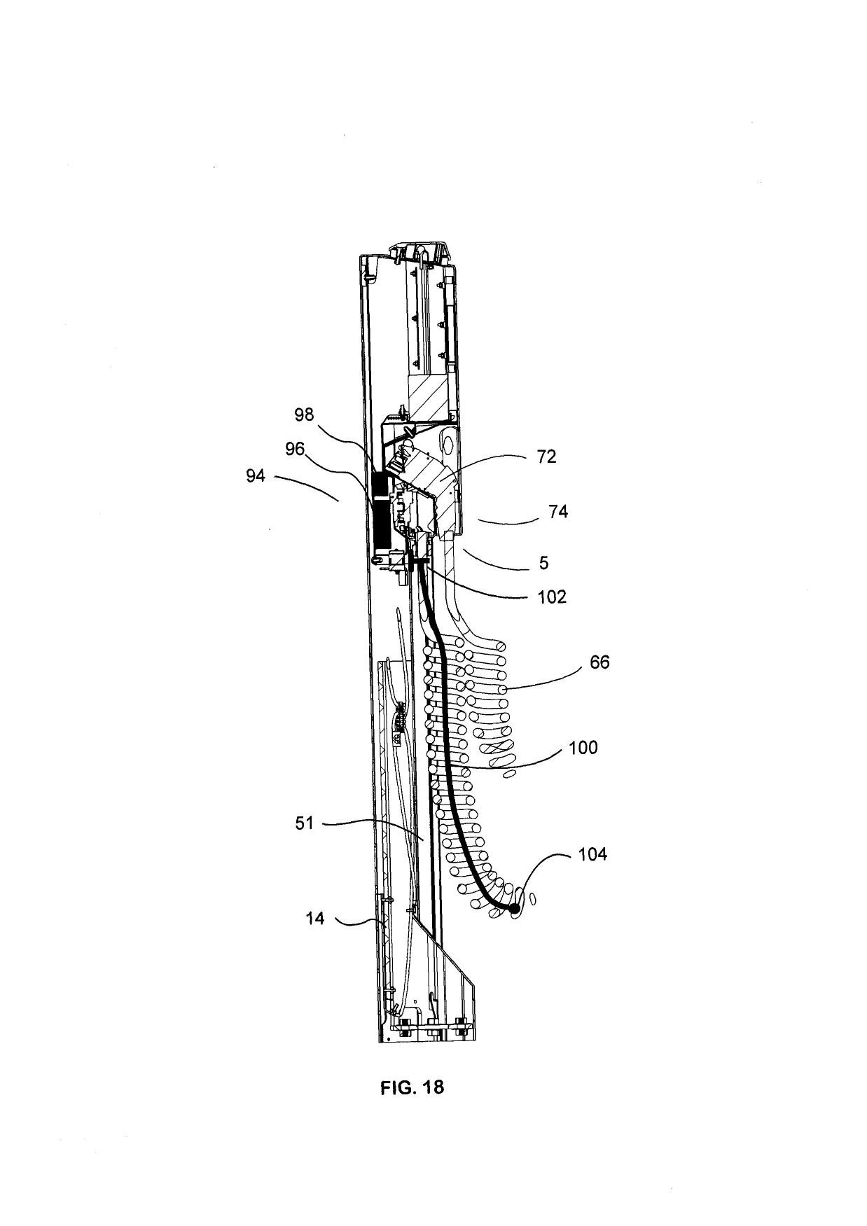

In a further embodiment, as shown in FIG. 18, the flexible conductive cable 66 is retractably mounted with respect to the frame 14. This may help returning the conductive cable 66 in its initial position after use. Indeed, after use, the user will replace the connector 72 in the receiving portion 74 of the distributing unit 50, as detailed below. The control unit 30 may detect that the user has finished his charging session and may operate a retracting mechanism 94 adapted for retracting the conductive cable 66 in the receiving portion 51.

In one embodiment, the retracting mechanism 94 comprises a motor 96 fixedly mounted to the frame 14 and a roller 98 driven by the motor 96. The retracting mechanism 94 further comprises a retracting cable 100, a steel cable for example, having a first end 102 connected to the roller 98 and a second end 104 attached to the conductive cable 66. In one embodiment and as illustrated, the retracting cable 100 may be attached to a middle portion of the conductive cable 66 although various other arrangements may be considered.

In one embodiment, the conductive cable 66 has a shape similar to a phone cable handset, although any other cable adapted for conducting the electrical energy may be used, as apparent to the skilled addressee. The retracting cable 100 may be mounted inside the conductive cable 66 in this embodiment.

Referring to FIGS. 5, 6A, and 6B, in one embodiment, the distributing unit 50 has a receiving portion 74 on its front face for receiving and holding the connector 72. The skilled addressee will nevertheless appreciate that various alternative configurations may be envisaged for holding the connector 72.

In one embodiment, the connector 72 comprises a SAE J1772 connector adapted for use in North America. In another embodiment, the connector 72 comprises a VDE-AR-E 2623-2-2 connector adapted for use in Europe. The skilled addressee will nevertheless appreciate that various other connectors may be used, provided it enables an operative connection between the charging station and the vehicle.

In one embodiment, the flexible conductive cable 66 comprises an aluminum conductor covered with a protective layer. Copper or any other suitable material may be used for the conductor. However, an aluminum conductor may be advantageous since it has suitable conductive properties while being much less expensive than an equivalent copper conductive cable. This may help discouraging theft and vandalism of the charging station, which is of great advantage.

Referring to FIG. 17, in one embodiment, the flexible conductive cable 66 comprises a handle 76 mounted proximate the connector 72 in order to provide an easy grip to the user. In a further embodiment, an additional handle 78 may also be provided on the cable 66 distal from the first handle 76 to further enhance manipulation of the cable 66.

In one embodiment, the distributing unit 50 may be provided with a position sensor (not shown) adapted for sensing presence and/or absence of the connector 72 in the corresponding receiving portion 74 thereof. This may encourage users to correctly replace the connector 72 in the receiving portion 74 after use. The control unit 30 may be adapted to terminate the transaction only if the position sensor detects that the connector 72 is positioned back in the receiving portion 74. The control unit may also be adapted to provide a visual or sound signal to the user indicating that the connector has not been replaced in the receiving portion 74. For example, the position sensor may be an optical position sensor, a mechanical position sensor, or the like. Indeed, the skilled addressee will appreciate that the identified user may be informed or even punished for failure to doing so. Other means adapted for detecting the presence of the connector 72 in the receiving portion 74 may be considered, as apparent to the skilled addressee.

In the case where the charging station 10 is used in harsh climatic conditions, this may enhance comfort of the users since the connector 72 should always be in its receiving portion 74 instead of running on the floor, in ice or snow for instance. Moreover, in such conditions, ensuring the connector 72 is not on the floor may also help reducing breaks caused by motorized snow removal.

In another embodiment, the energy providing means 64 does not comprise a flexible conductive cable 66. Instead, the energy providing means 64 comprises an electrical connector (not shown) such as a plug for example mounted to the distributing unit 50. In this case, the user may use his own electrical cable to connect the batteries of the vehicle to the plug of the distributing unit 50, as apparent to the skilled addressee.

Referring to FIGS. 1 and 2, in one embodiment, the charging station 10 comprises a communication unit 80 mounted on the top of the control unit 30 or on the top of the frame 14. The communication unit 80 may comprise an antenna for enabling RF communication between the charging station 10 and the vehicle or a portable identification device for example. In a further embodiment, the communication unit 80 may enable a wireless communication over a network with a remote central control station operating a set of charging stations, as known to the skilled addressee. In one embodiment, the communication unit 80 may be used for updating the embedded software stored in a memory and executed by the processing unit of the control unit 30 of the charging station 10.

In one embodiment, the modular charging station 10 comprises an electricity meter for measuring the amount of electrical energy consumed during a charge of a vehicle. The electricity meter is operatively connected to the control unit 30 which receives the amount of consumed energy for invoicing the user.

In one embodiment, the control unit 30 comprises a user interface mounted on its front face. The user interface may comprise a display for displaying various information to the user, such as instructions for operating the charging station, the cost of the battery recharge, and the like, as well as a set of light-emitting diodes (LEDs) used for providing visual indications such as the state of the charging station 10 for example.

In one embodiment, the control unit 30 comprises a credit card reader operatively connected to the processing unit. The information about the user's credit card is provided by the credit card reader to the control unit 30 which transmits the credit card information to a remote server via the communication unit 80. The remote server validates the credit card information and returns a validation signal to the control unit 30. Upon reception of the validation signal, the processing unit powers the energy providing means 64.

In a further embodiment, the control unit 30 comprises an identification means for identifying the user and powering the energy providing means 64 following a successful identification of the user.

For example, a user may have to preregister before using the charging station 10 and is provided with an identification (ID). The ID may be a barcode, a radio-frequency identification (RFID) tag, a password, a conventional credit card, or the like. The control unit 30 comprises an adequate ID input device adapted to receive the user ID. For example, the ID input device may be a keyboard that may be used by the user to enter his password. In another example, the ID input device may be a barcode reader. In a further example, the ID input device may be an RFID tag reader.

The ID input device receives the user ID and transmits it to the processing unit of the control unit 30. In one embodiment, a list of authorized users is stored on the memory of the control unit 30. The processing unit compares the user ID received from the ID input device to the stored list of authorized users to verify the user identity. Upon successful verification, the control unit 30 powers the energy providing means 64. In another embodiment, the verification may be remotely performed on a server. In this case, the control unit 30 sends, via the communication unit 80, the user ID to a remote server which verifies the user identity. Upon reception of a signal indicative of a successful verification from the remote server, the control unit 30 powers the energy providing means 64.

In one embodiment, the communication unit 80 may comprise a plastic casing fixedly mounted on the top of the frame 14 for enabling a suitable transmission of RF signals therethrough, although other arrangements may be considered.

The skilled addressee will appreciate that the electronics is embedded in the control unit 30 and in the distributing unit 50. This may be of great advantage from a maintenance point of view since the control unit 30 and the distributing unit 50 may be easily replaced with similar components. Moreover, once the charging station has been initially installed, typically with the help of a certified electrician, the control unit 30 and the distributing unit 50 may be replaced by technicians, thereby reducing the maintenance costs associated with the operation of the charging station.

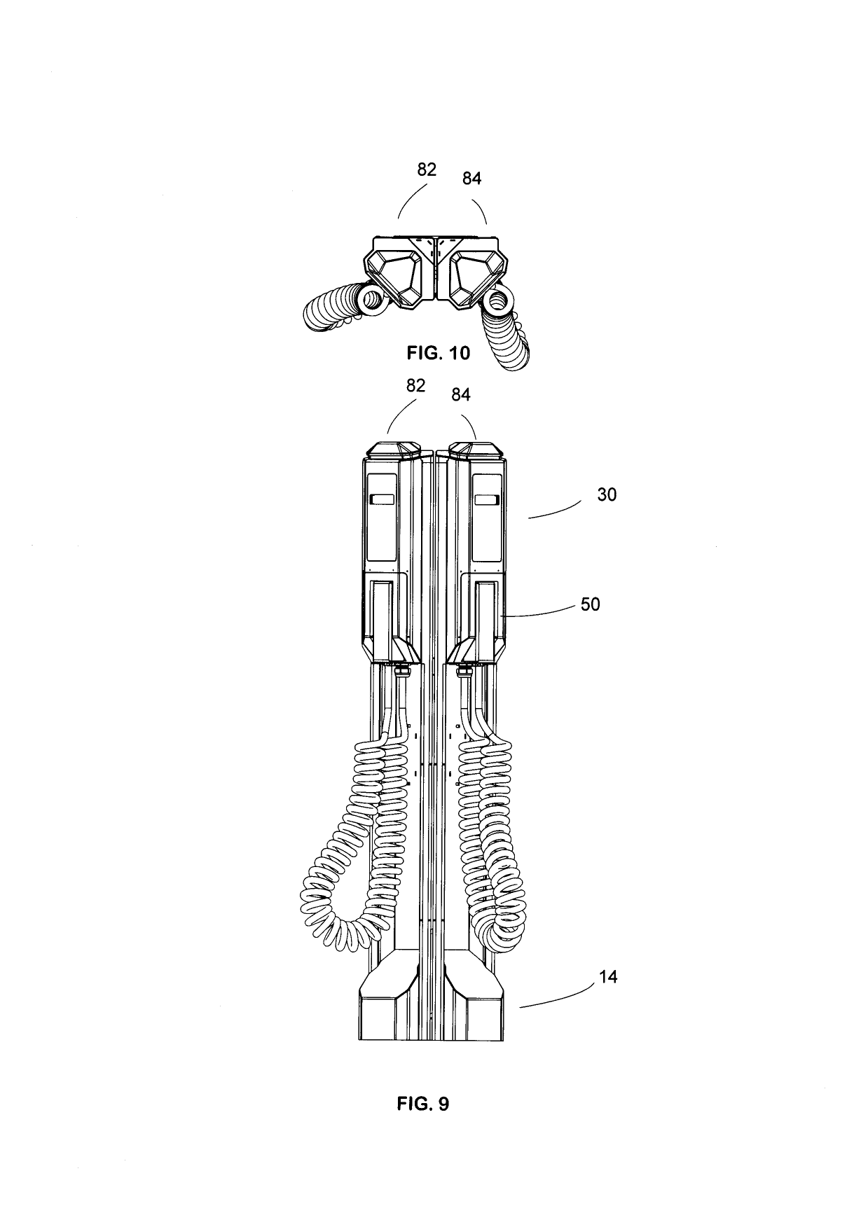

Referring to FIGS. 9 and 10, in one embodiment, the frame 14 comprises two adjacent extrusions 82, 84, each receiving a corresponding control unit 30 and a corresponding distributing unit 50.

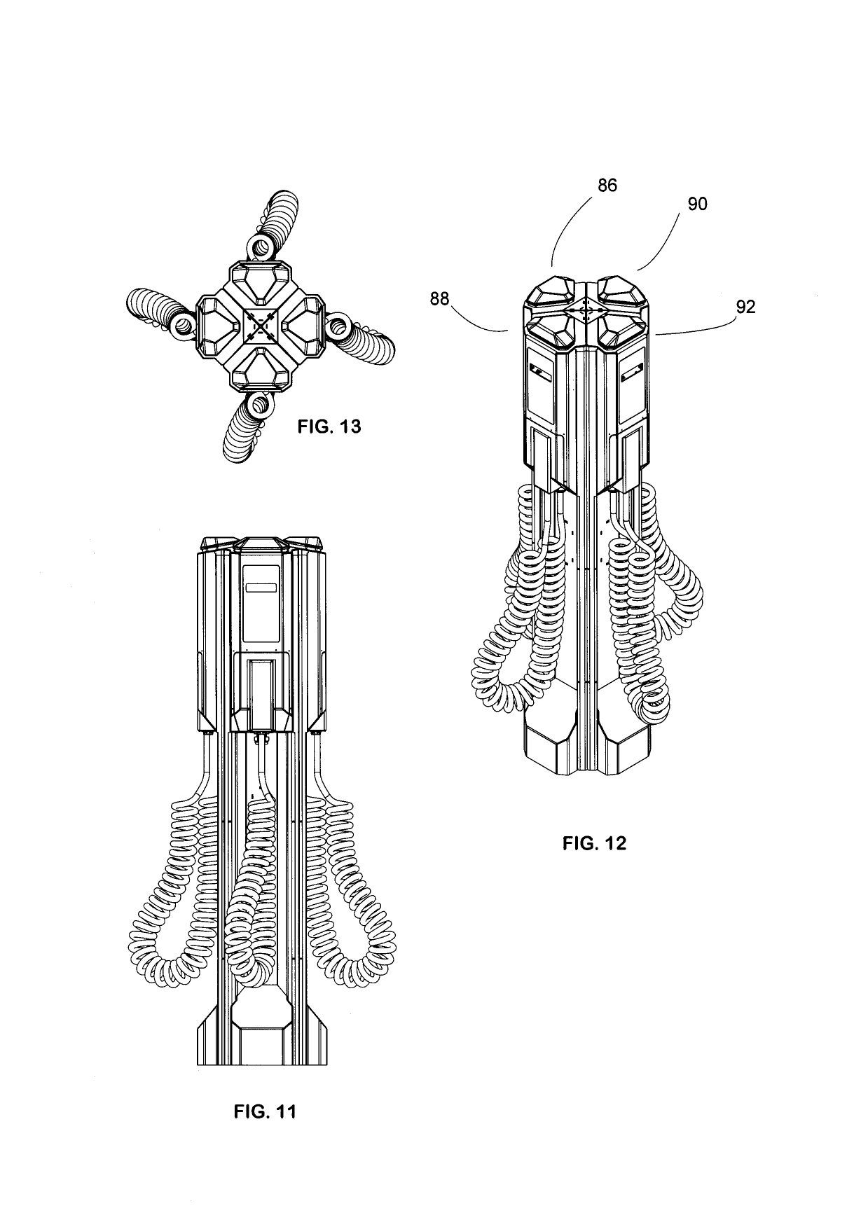

In FIGS. 11 to 13, the frame comprises four adjacent elongated extrusions 86, 88, 90, 92 mounted perpendicularly to each other. This configuration may provide four different users at the same time with four distinct points of charge with a single connection to the power grid.

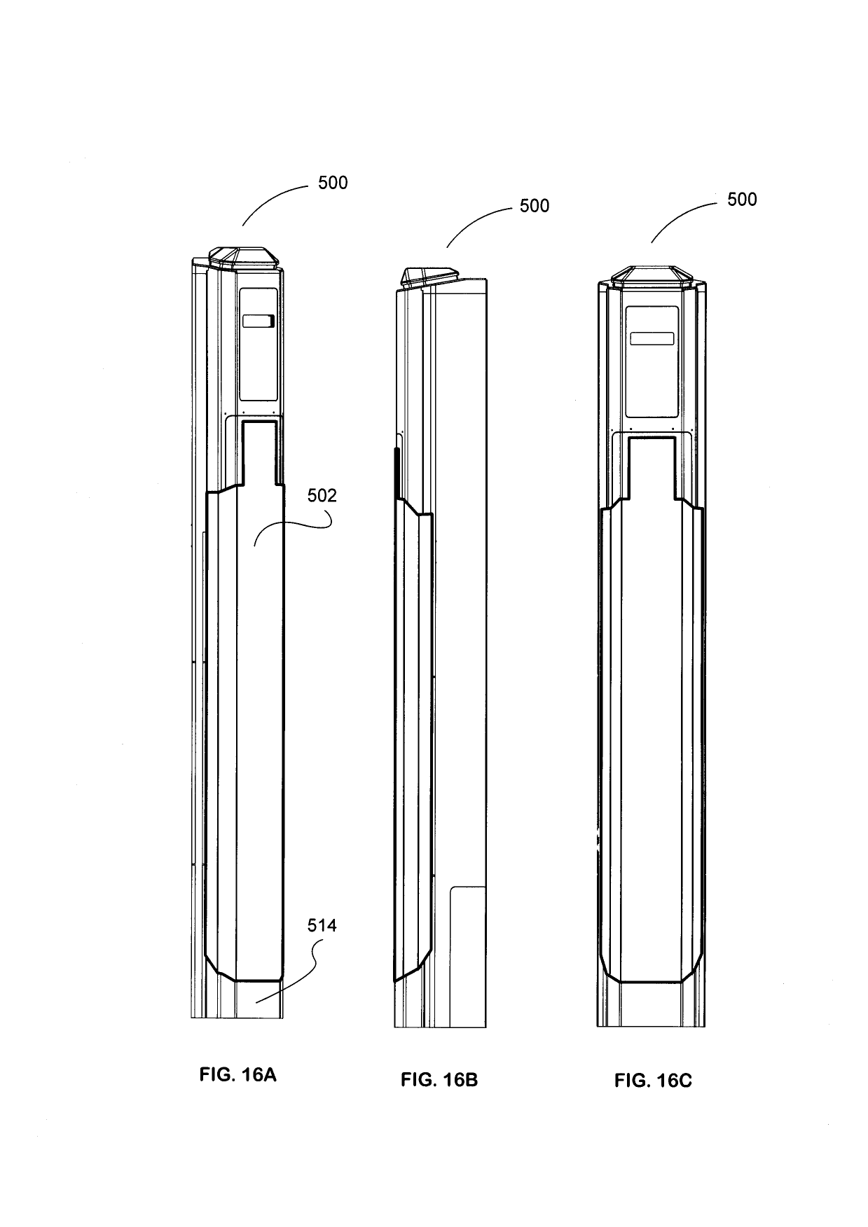

Referring to FIGS. 16A to 16C, in one embodiment, the charging station 500 may be provided with a hinged door 502 operatively connected to the frame 514 for protecting the connector 72 and the conductive cable 66 from surroundings when the charging station is not in used.

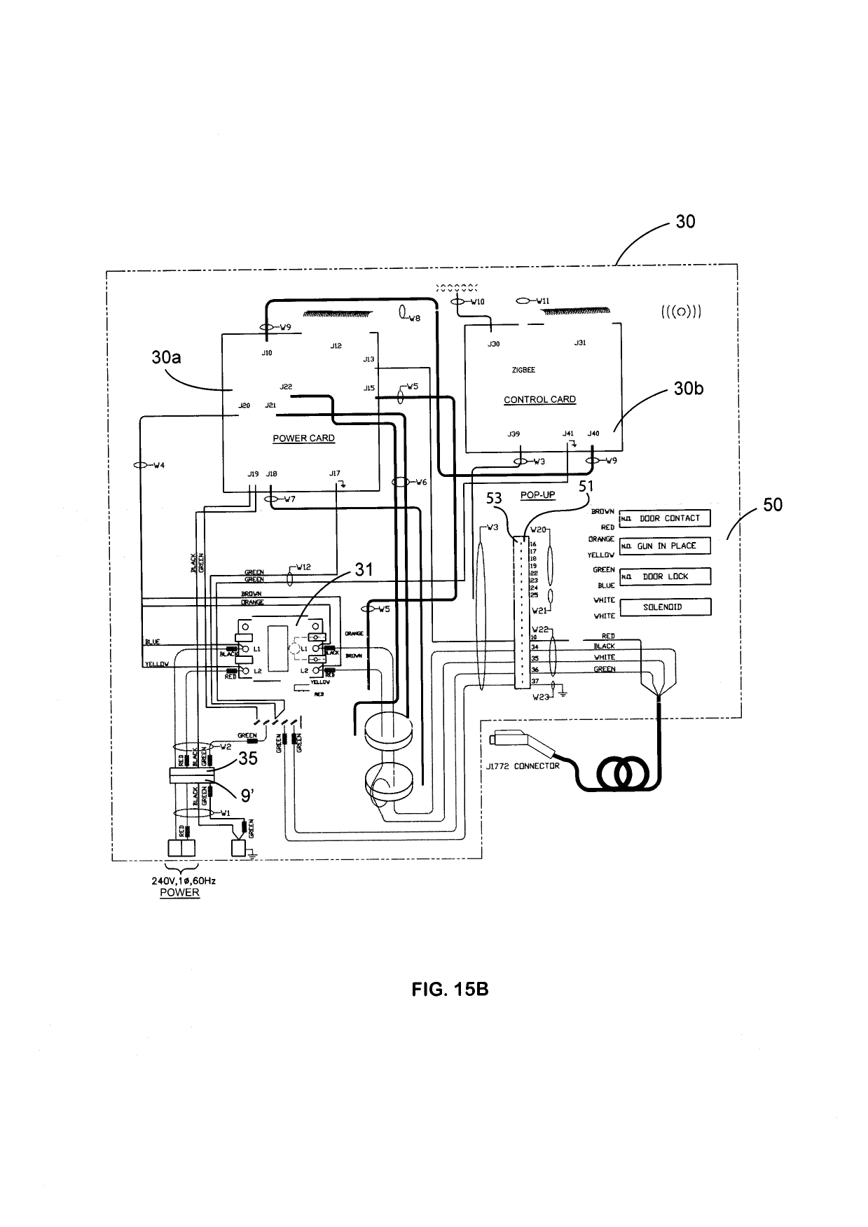

FIGS. 15A and 15B illustrate one embodiment of the cooperation and connection between the control unit 30 and the distributing unit 50. The control unit 30 comprises a power card 30a, a control card 30b, an electrical switch 31 such as a magnetic contactor switch for example, and two electrical connectors 35 and 53. The electrical connector 35 is removably connected to the connector 9′ to receive the electrical energy for powering the components of the control unit 30 and the distributing unit 50, and the vehicle to be recharged. The switch 31 is electrically connected to the connector 35 and the connector 53 to selectively power the connector 53. The switch 31 is activated by the power card 30a. The power card 30a and the control card 30b are connected together. When it determines that the distributing unit 50 has to be powered, the control card 30b sends a first signal to the power card 30a which turns on the switch 31 upon reception of the first signal. Similarly, when the control card 30b sends a second signal indicative that the distributing unit 50 should not be powered to the power card 30a, the power card 30a turns off the switch 31.

In one embodiment, the distributing unit 50 comprises a connector 51, a door sensor for determining whether the door 502 is open or closed, a position sensor for determining whether the connector 72 is positioned in its receiving portion, a lock sensor for determining whether the door 502 is locked, and a solenoid for activating a lock mechanism for locking the door 502. The different sensors and the solenoid are electrically connected to the connector 51. The distributing unit 50 further comprises a vehicle connector, such as connector 72 for example, electrically connected to the connector 51 via a cable such as cable 66. The communication between the sensors and the solenoid, and the control card 30b occurs via the connectors 51 and 53 so that the control card 30b may control the powering of the vehicle connector and the locking mechanism solenoid of the door 502 as a function of the signals received from the different sensors. The powering of the sensors, the solenoid, and the vehicle connector also occurs through the connectors 51 and 53. The connectors 51 and 53 form a door between the control unit 30 and the distributing unit 50, through which all communication and powering signals pass.

In one embodiment, the control card 30b is connected to an antenna for communicating to a remote server for example, and LEDs for informing a user of the charging station.

In one embodiment, the control unit 30 comprises two inductors, such as a Ground Fault Circuit Interrupter (GFCI) coil and a meter coil for example, positioned between the switch 31 and the connector 53, and controlled by the power card 30a. The vehicle connector is connected to the power card 30a through the connectors 51 and 53 so that a signal for controlling the electrical energy provided to the vehicle may propagate from the vehicle connector to the power card. Upon reception of this control signal, the power card 30a adjusts the electrical current provided to the vehicle via the two inductors.

The embodiments embodying several points of charge may be particularly advantageous for an operator of a group of a plurality of charging stations. Indeed, the costs associated with the installation of the charging stations may be greatly reduced while providing a suitable number of points of charge. Indeed, the connection to the power grid may be initially adapted for receiving four points of charge for example even if the frame is initially configured for receiving a single point of charge. When the operator decides to expand his business by increasing the number of points of sale, the installation may be made by a technician without requiring a certified electrician since the frame may be changed for another frame adapted to provide a plurality of points of sale. The skilled addressee will appreciate that this is of great advantage. The control units 30 will be connected to the power grid without expensive costs.

As it should become apparent to the skilled addressee, the modular design of the charging station is particularly advantageous since it enables a mass production of similar parts, while providing a charging station adapted for any country in the world. This may contribute to lower the manufacturing costs, which is of great advantage. Moreover, as it should be understood upon reading of the present description, the number of parts required is minimized, thus reducing even more the costs associated to a charging station. Furthermore, the installation is simplified, thus also reducing installation and maintenance costs.

In one embodiment, the charging station may also be used to inject reverse flow power back into the electric grid and receive credit for this, as known to the skilled addressee.

In another embodiment, dynamic electrical rates may be taken into account to minimize the cost of electricity or maximize the credit. In this case, the charging station may be adapted to communicate with a rate advisory service to provide a current rate for electricity. In one embodiment, the user may cause the beginning of charging to be delayed until a certain rate is reached with optional override at a certain time if the chosen rate is not reached. This is especially attractive for charging at night where rates may drop later in the night due to less demand for electricity.

The skilled addressee will appreciate that in one embodiment, the described charging station is well adapted for used in harsh climatic conditions. Indeed, the frame, the control unit and the distributing unit are mounted together using snuggly couplings between the elements. This may help preventing debris, sand and precipitation from accumulating inside the charging station. The communication unit which is installed on the top of the frame for enhancing communication may also be snuggly mounted with the frame for preventing unwanted insertion of debris in the charging station.

Moreover, the position sensor is devised to encourage users to position the connector in its correct position after use. Furthermore, the cable 66 is retracted inside the frame when not in use in one embodiment. This helps protecting the cable against precipitation which may otherwise soil the cable and then eventually the suit of the user.

Although the above description relates to specific preferred embodiments as presently contemplated by the inventors, it will be understood that the invention in its broad aspect includes mechanical and functional equivalents of the elements described herein. Moreover, although the invention has been described in the particular field of electricity dispensing for electric or hybrid vehicles, it should be understood that the invention may be used in various other applications such as the charging of portable devices for a non-limitative example.

1. A modular charging station for charging an electric vehicle, the modular charging station comprising:
a frame having a receiving portion;
a control unit removably secured to the receiving portion of the frame and electrically connectable to a source of electrical energy, the control unit for selectively controlling access to the electrical energy; and
a distributing unit removably secured to the frame, electrically connected to the control unit for receiving the electrical energy therefrom, and electrically connectable to the electric vehicle for providing the electrical energy to the electric vehicle, a powering of the distributing unit being controlled by the control unit.

2. The modular charging station of claim 1, wherein the control unit comprises a receiving cavity for removably receiving the distributing unit therein.

3. The modular charging station of claim 2, wherein a shape of a rear face of the control unit matches a shape of the receiving cavity for a snuggly relationship between the control unit and the frame.

4. The modular charging station of claim 3, wherein the frame comprises an elongated V-shaped extrusion.

5. The modular charging station of claim 2, wherein the control unit comprises a switch for activating a powering of the distributing unit, a first electrical connector connected to the switch and connectable to the source of electrical energy, and a second electrical connector connected to the switch and the distributing unit.

6. The modular charging station of claim 5, wherein the distributing unit comprises a third electrical connector electrically connected to the second electrical connector for receiving the electrical energy therefrom.

7. The modular charging station of claim 6, wherein the first, second, and third electrical connectors each comprise a plug-in connector.

8. The modular charging station of claim 1, wherein the distributing unit comprises a vehicle electrical connector adapted to connect to the electric vehicle.

9. The modular charging station of claim 8, wherein the vehicle electrical connector is fixedly secured to a connector receiving portion of the distributing unit.

10. The modular charging station of claim 8, further comprising a flexible cable electrically connecting the vehicle electrical connector to the distributing unit, the distributing unit further comprising a connector receiving portion for holding the vehicle electrical connector thereon.

11. The modular charging station of claim 10, wherein the frame further comprises a cable receiving portion for receiving the flexible cable.

12. The modular charging station of claim 11, further comprising a retracting mechanism for retracting the flexible cable in the cable receiving portion.

13. The modular charging station of claim 10, further comprising a handle secured to the flexible cable.

14. The modular charging station of claim 10, further comprising a position sensor operatively connected to the control unit, the position sensor for determining whether the vehicle electrical connector is positioned on the connector receiving portion.

15. The modular charging station of claim 14, wherein the processing unit of the control unit is configured for terminating a transaction only if the position sensor detects that the vehicle electrical connector is positioned on the connector receiving portion.

16. The modular charging station of claim 1, wherein the frame comprises a further receiving portion for removably receiving the distributing unit, the distributing being directly and removably to the frame.

17. The modular charging station of claim 1, wherein the control unit comprises an identification module for identifying a user and powering the energy providing means upon successful identification of the user.

18. The modular charging station of claim 1, further comprising a communication unit for remote communication.

19. The modular charging station of claim 1, wherein the control unit comprises an electricity meter for measuring an amount of electrical energy consumed during the charging of the vehicle.
